(19) United States
(12) Patent Application Publication
(10) Pub. No.: US 2007/0205967 A1
(43) Pub. Date: Sep. 6, 2007

(54) Plasma display device and driving method thereof

(76) Inventors: Tae-Hyun Kim, Yongin-si (KR); Joo-Yul Lee, Yongin-si (KR); Byeong-Seon Min, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 11/713,629

(22) Filed: Mar. 5, 2007

(30) Foreign Application Priority Data
Mar. 6, 2006 (KR) 10-2006-0020887

(51) Int. Cl. G09G 3/28

(52) U.S. Cl. 345/67

(57) ABSTRACT

A plasma display device and a driving method according to the present invention erase more wall charges formed on electrodes by controlling a voltage applied to a sustain electrode and a scan electrode during a falling period of a reset period of the next subfield as the number of sustain discharge pulses applied to the scan electrode and the sustain electrode during a sustain period of a previous subfield increases. Different waveforms may be used during the falling period of the reset period for different subfields, to vary a number of wall charges that may be erased.

### BACKGROUND OF THE INVENTION

1. Field of the Invention

The present invention relates to a plasma display device and a driving method thereof.

2. Description of the Related Art

A plasma display device is a flat panel display that uses plasma generated by a gas discharge to display characters or images. A plasma display device includes a plasma display panel (PDP) wherein, depending on size, tens to millions of discharge cells (hereinafter, referred to as “cells”) are arranged in a matrix format.

According to a typical driving method of a PDP, each frame may be divided into a plurality of subfields having respective weights. Luminance of a discharge cell may be determined by a sum of weights of subfields at which the corresponding discharge cell is turned on among the plurality of subfields.

Each subfield may include a reset period, an address period, and a sustain period. The reset period is for initializing the status of each discharge cell. The address period is for performing an addressing operation so as to select light emitting cells. The sustain period is for displaying an image by sustain-discharging the light emitting cells selected in the address period for a period that corresponds to a weight of the corresponding subfield.

An amount of wall charges formed on a sustain electrode and a scan electrode after a sustain period may vary depending on the number of sustain discharge pulses applied to the sustain electrode and the scan electrode during the sustain period of the corresponding subfield. Particularly, when numerous wall charges are formed on the sustain electrode and the scan electrode after the sustain period is terminated, the wall charges may be insufficiently erased during a reset period of the next subfield. Thus, an address period and a sustain period of the next subfield may misfire.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention is therefore directed to a plasma display device and a driving method thereof, which substantially overcome one or more of the disadvantages of the related art.

It is therefore a feature of an embodiment of the present invention to provide a plasma display preventing occurrence of misfiring by efficiently erasing wall charges when numerous wall charges are accumulated on the scan electrode and the sustain electrode after a sustain period of a previous subfield is ended, and a driving method thereof.

It is therefore another feature of an embodiment of the present invention to provide falling periods within a reset period between subfields that having characteristics corresponding to a number of sustain discharges in a previous subfield.

At least one of the above and other feature and advantages of the present invention may be realized by providing a method for driving a plasma display having a plurality of first electrodes and a plurality of second electrodes, wherein one frame for driving the plasma display is divided into a plurality of subfields including a first subfield and a second subfield that is consecutive to the first subfield, the method including, for a falling period of a reset period of the first subfield, applying a first waveform capable of erasing a first number of wall charges, and, for a falling period of a reset period of the second subfield, applying a second waveform capable of erasing a second number of wall charges, the first number and the second number being different.

For a sustain period of each of the plurality of subfields, a sustain discharge pulse may be alternately applied to the first and second electrodes, wherein the number of sustain discharge pulses of the second subfield may be greater than the number of sustain discharge pulses of the first subfield. The first number may be less than the second number. The reset period of the second subfield is an auxiliary reset period may have only the falling period.

Applying the first waveform may include maintaining a voltage of the plurality of second electrodes at a third voltage during a first period after gradually decreasing the voltage of the plurality of second electrodes to the third voltage from a second voltage while biasing the plurality of first electrodes with a first voltage, and applying the second waveform may include maintaining the voltage of the plurality of second electrodes at the third voltage during a second period after gradually decreasing the voltage of the plurality of second electrodes to the third voltage while biasing the plurality of first electrodes with the first voltage. The second period may be longer than the first period.

Applying the first waveform may include gradually decreasing a voltage of the plurality of second electrodes from a second voltage to a third voltage with a first slope while a voltage of the plurality of first electrodes is biased with a first voltage, and applying the second waveform may include gradually decreasing the voltage of the plurality of second electrodes from the second voltage to a third voltage with a second slope while the voltage of the plurality of first electrodes is biased with the first voltage. The second slope may be steeper than the first slope.

Applying the first waveform may include gradually increasing a voltage difference between the plurality of first electrodes and the plurality of second electrodes to a first voltage, and applying the second waveform includes gradually increasing the voltage difference between the plurality of first electrodes and the plurality of second electrodes to a second voltage. The second voltage may be greater than the first voltage.

For the falling period of the reset period of the first subfield, the voltage of the plurality of second electrodes may gradually decrease from a fourth voltage to a fifth voltage while the voltage of the plurality of first electrodes is biased with a third voltage, and for the falling period of the reset period of the second subfield, the voltage of the plurality of second electrodes may gradually decrease from the fourth voltage to a sixth voltage while the voltage of the plurality of first electrodes is biased with the third voltage, the sixth voltage being less than the fifth voltage.

The voltage of the plurality of second electrodes may gradually decrease from a fourth voltage to a fifth voltage while the voltage of the plurality of first electrodes is biased with a third voltage for the falling period of the reset period of the first subfield, and the voltage of the plurality of second electrodes may gradually decrease from the fourth voltage to the fifth voltage while the voltage of the plurality of first electrodes is biased with a sixth voltage, the sixth voltage being greater than the third voltage.

The voltage of the plurality of first electrodes may be floated at a first time in a period during which the voltage of the plurality of second electrodes is gradually decreased from a third voltage to a fourth voltage for a falling period of the reset period of the first subfield, the voltage of the plurality of first electrodes may be floated at a second time while the voltage of the plurality of second electrodes from the third voltage to the fourth voltage for a falling period of the reset period of the second subfield, and the second time may be later than the first time. The plurality of first electrodes may be floated after being biased with a fifth voltage that is less than the third voltage.

At least one of the above and other feature and advantages of the present invention may be realized by providing plasma display, including a plasma display panel including a plurality of first electrodes, a plurality of second electrodes, a plurality of third electrodes formed crossing the first and second electrodes, and a discharge cell formed by the first, second, and third electrodes, a controller for dividing one frame into a plurality of subfields including a first subfield and a second subfield that is consecutive to the first subfield, and driving them, and a driver for applying a first waveform capable of erasing a first number of wall charges during a falling period of a reset period of the first subfield, and for applying a second waveform capable of erasing a second number of wall charges during a falling period of a reset period of the second subfield, the first number and the second number being different.

The driver may alternately apply a sustain discharge to the first electrodes and the second electrodes for a sustain period of each of the plurality of subfields, and may alternately apply more sustain discharge pulses to the first and second electrodes during a sustain period of the second subfield than a sustain period of the first subfield.

The driver may gradually decrease a voltage of the plurality of second electrodes from a second voltage to a third voltage with a first slope while a voltage of the plurality of first electrodes is biased with a first voltage during the first waveform, and may gradually decrease the voltage of the plurality of second electrodes from the second voltage to the third voltage with a second slope while the voltage of the plurality of first electrodes is biased with the first voltage during the second waveform. The second slope may be steeper than the first slope.

The driver may maintain a voltage of the second electrodes at a third voltage level for a first period after decreasing the voltage of the second electrodes from a second voltage to the third voltage during the first waveform, and may maintain the voltage of the second electrodes at the third voltage level for a second period after decreasing the voltage of the second electrodes from the second voltage to the third voltage during the second waveform. The second period may be greater than the first period.

The driver may gradually increase a voltage difference between the first and second electrodes to a first voltage during the first waveform, and may gradually increase the voltage difference between the first and second electrodes to a second voltage during the second waveform. The second voltage is greater than the first voltage.

The driver may gradually decrease a voltage of the second electrode from a fourth voltage to a fifth voltage while a voltage of the first electrode is biased with a third voltage during the first waveform, and may gradually decrease a voltage of the second electrode from the fourth voltage to a sixth voltage while the voltage of the first electrode is biased with the third voltage during the second waveform, the sixth voltage being less than the fifth voltage.

The driver may gradually decrease the voltage of the second electrode from a fourth voltage to a fifth voltage while the voltage of the first electrode is biased with a third voltage during the first waveform, and may gradually decrease the voltage of the second electrode from the fourth voltage to the fifth voltage while the voltage of the first electrode is biased with a sixth voltage, the sixth voltage may be greater than the third voltage.

The driver may float the voltage of the first electrode at a first time while gradually decreasing the voltage of the second electrode from a third voltage to a fourth voltage the first waveform, and may float the voltage of the first electrode at a second time while gradually decreasing the voltage of the second electrode from the third voltage to the fourth voltage during the second waveform, the second time may be later than the first time. The voltage of the first electrode is floated after biasing the first electrode with a fifth voltage that is less than the third voltage.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a schematic view of a plasma display apparatus according to an exemplary embodiment of the present invention;

FIG. 2 illustrates a driving waveform of the plasma display apparatus according to the exemplary embodiment of the present invention;

FIG. 3A illustrates a state of wall charges formed on each electrode after a reset period of the next subfield when an relatively low number of sustain discharge pulses are generated during a sustain period of a previous subfield;

FIG. 3B illustrates a state of wall charges formed on each electrode after the reset period of the next subfield when a relatively large number of sustain discharge pulses is generated during the sustain period of the previous subfield;

FIG. 4 illustrates a driving waveform diagram of a plasma display apparatus according to a first exemplary embodiment of the present invention;

FIG. 5 illustrates a driving waveform diagram of a plasma display apparatus according to a second exemplary embodiment of the present invention;

FIG. 6 illustrates a driving waveform diagram of a plasma display apparatus according to a third exemplary embodiment of the present invention;

FIG. 7 illustrates a driving waveform diagram of a plasma display apparatus according to a fourth exemplary embodiment of the present invention; and

FIG. 8 illustrates a driving waveform diagram of a plasma display apparatus according to a fifth exemplary embodiment of the present invention.

### DETAILED DESCRIPTION OF THE INVENTION

Korean Patent Application No. 10-2006-0020887 filed on Mar. 6, 2006, in the Korean Intellectual Property Office, and entitled: “Plasma Display Device and Driving Method Thereof,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The wall charges being described in the present invention are charges formed on a wall (e.g., a dielectric layer) close to each electrode of a discharge cell. The wall charges will be described as being “formed” or “accumulated” on the electrode, although the wall charges do not actually touch the electrodes. Further, a wall voltage is a potential difference formed on the wall of the discharge cell by the wall charges.

A plasma display and a driving method thereof according to an exemplary embodiment of the present invention will now be described in further detail with reference to the accompanying drawings.

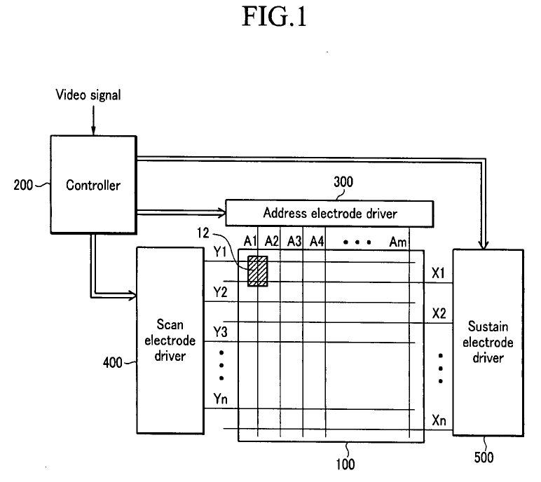

FIG. 1 illustrates a schematic view of a plasma display according to the exemplary embodiment of the present invention.

As shown in FIG. 1, the plasma display apparatus according to the exemplary embodiment of the present invention may include a plasma display panel (PDP) 100, a controller 200, an address electrode driver 300, a scan electrode driver 400, and a sustain electrode driver 500.

The PDP 100 may include a plurality of address electrodes A1 to Am extending in a column direction, and a plurality of sustain and scan electrodes X1 to Xn and Y1 to Yn extending in a row direction by pairs. Hereinafter, the address electrode, the sustain electrode, and the scan electrode will be respectively referred to as an A electrode, an X electrode, and a Y electrode. In general, the X electrodes X1 to Xn respectively correspond to the Y electrodes Y1 to Yn, and the Y and X electrodes and the A electrode are disposed to face each other. A discharge space formed where the A electrodes A1 to Am and the X and Y electrodes X1 to Xn and Y1 to Yn intersect may form a discharge cell 12.

The controller 200 may receive an external video signal, may output a driving control signal, and may divide one frame into a plurality of subfields, each having a weight.

The drivers 300, 400, and 500 may respectively apply a voltage for a reset discharge to the A electrodes A1 to Am, the X electrodes X1 to Xn, and the Y electrodes Y1 to Yn so as to initialize discharge cells. In this case, a reset period of a partial subfield among the plurality of subfields may be formed of a main reset period that can generate a reset discharge in all discharge cells, and a reset period of the rest of the subfields may be formed of an auxiliary reset period that can generate a reset discharge in discharge cells that have experienced a sustain discharge in the previous subfield.

During an address period, a scan electrode driver 400 may sequentially apply a scan pulse to the Y electrodes Y1 to Yn, and the address electrode driver 300 may apply an address pulse to a corresponding A electrode to distinguish light emitting cells and non-light emitting cells when the scan pulse is applied to each of the Y electrodes Y1 to Yn. During a sustain period, the sustain electrode driver 500 and the scan electrode driver 400 may apply a voltage to the X electrodes X1 to Xn and the Y electrodes Y1 to Yn for a sustain discharge.

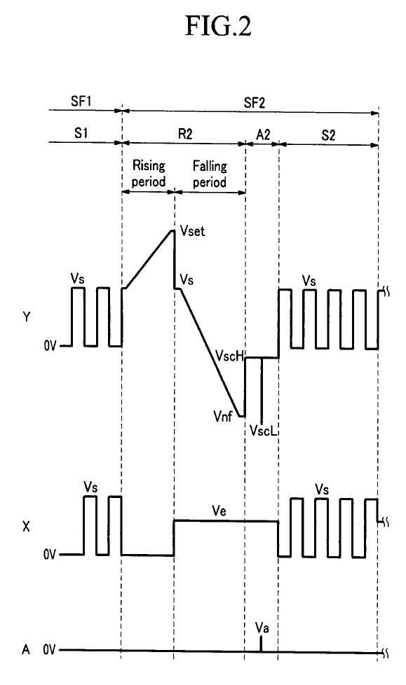

A driving waveform applied to the A electrodes A1 to Am, X electrodes X1 to Xn, and the Y electrodes Y1 to Yn in each subfield will be described in further detail with reference to FIG. 2 to FIG. 6. A cell formed by one A electrode, one X electrode, and one Y electrode will be described for better understanding and ease of description.

According to the exemplary embodiment of the present invention, a voltage waveform applied to the Y and X electrodes during a reset period of the next subfield may be controlled in accordance with the amount of wall charges accumulated on the Y electrode and the X electrode after a sustain period of a previous subfield is terminated, so as to make the state of the wall charge appropriate for an addressing operation. In the following description, a variety of voltage waveforms applied to the Y electrode and the X electrodes will be respectively described with reference to the corresponding drawings.

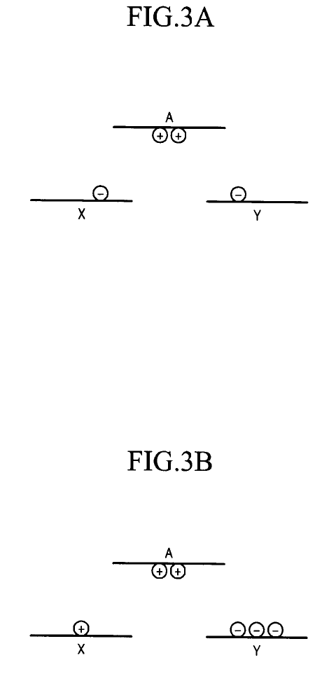

FIG. 2 illustrates a driving waveform of the plasma display apparatus according to the exemplary embodiment of the present invention, and shows a sustain period of a first subfield and a second subfield for ease of description. In addition, FIG. 3A and FIG. 3B illustrate a wall charge state after the reset period of the second subfield is terminated after a relatively low number and a relatively high number of sustain discharge pulses are respectively during the sustain period of the first subfield.

As shown in FIG. 2, each subfield may include a reset period, an address period, and a sustain period, and the reset period may include a rising period and a falling period.

That is, as shown in FIG. 2, a voltage of the X electrode may be maintained at 0V during the rising period of the reset period R2 of the second subfield while a voltage of the Y electrode is increased from a voltage of Vs to a voltage of Vset. Then, a weak reset discharge may be generated to the X electrode and to the A electrode from the Y electrode so that negative (−) wall charges may be formed on the Y electrode and positive (+) wall charges may be formed on the A and X electrodes.

During the falling period of the reset period R2, the voltage of the Y electrode may be decreased to a voltage of Vnf from the Vs voltage while the voltage of the X electrode may be maintained at a voltage of Ve. While the voltage of the Y electrode is decreased, a weak reset may be generated between the Y and X electrodes and between the Y and A electrodes, so that the negative wall charges formed on the Y electrode and the positive wall charges formed on the X and A electrodes may be erased. When a relatively low number of sustain discharge pulses are applied during the previous subfield, a small amount of positive wall charges may remain on the A electrode and a small amount of negative wall charges may remain on the Y and X electrodes, as shown in FIG. 3A.

Subsequently, a scan pulse having a voltage of VscL may be sequentially applied to the Y electrodes so as to select discharge cells, and a Y electrode to which the VscL voltage is not applied is biased with a voltage of VscH during an address period A2. In this case, the VscL voltage may be called a scan voltage and the VscH voltage may be called a non-scan voltage. An address pulse having a voltage of Vs is applied to an A electrode that passes discharge cells to be selected among a plurality of discharge cells formed by the Y electrodes to which the VscL voltage is applied, and an A electrode to which the address pulse is not applied is biased with a reference voltage (0V in FIG. 2). Then, a discharge cell formed by the A electrode applied with the Va voltage and the Y electrode applied with the VscL voltage may experience an address discharge so that positive wall charges are formed on the Y electrode and negative wall charges may be formed on the X electrode. In addition, the negative wall charges may be formed on the A electrode.

A sustain discharge pulse having the Vs voltage may be alternately applied to the Y electrode and the X electrode during a sustain period S2. When a wall voltage is formed between the Y electrode and the X electrode by the address discharge during the address period A2, a discharge may be generated between the Y electrode and the X electrode due to the wall voltage and the Vs voltage. That is, the sustain pulse having the Vs voltage may be alternately applied to the Y electrode and the X electrode.

When a relatively high number of sustain discharge pulses are applied during the sustain period S1 of the first subfield, a lot of positive and negative wall charges may be formed on the Y electrode and the X electrode. Accordingly, the wall charges may not be sufficiently erased even though the reset period R2 of the second subfield is terminated as shown in FIG. 3B.

That is, as shown in FIG. 3B, (+) wall charges formed on the X electrode and (−) wall charges formed on the Y electrode may result in a discharge cell that is not to be selected during an address period being addressed, i.e., misfiring may occur.

Therefore, an initialization method for a stable address operation by sufficiently erasing wall charges during a reset period of the next subfield in the case that numerous wall charges are formed on the Y and X electrodes after a sustain period is terminated will be described in first to fifth exemplary embodiments of the present invention.

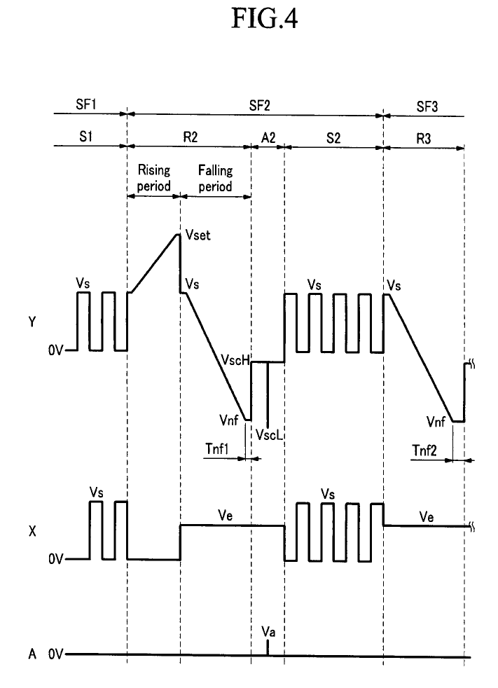

Hereinafter, for better understanding and ease of description, assume that a number of sustain discharge pulses increases as a subfield number increases. In FIG. 4 to FIG. 9, a sustain period S1 of a first subfield SF1, a second subfield SF2, and a reset period R3 of a third subfield SF3 are illustrated.

FIG. 4 illustrates a driving waveform diagram of a plasma display device according to a first exemplary embodiment of the present invention.

As shown in FIG. 4, according to the first exemplary embodiment of the present invention, wall charges may be efficiently erased by controlling a period for applying a Vnf voltage to the Y electrode during a falling period of a reset period of the next subfield when a previous subfield has a lot of sustain discharge pulses. For example, a length of a period for applying a Vnf voltage may correspond to a number of sustain discharge pulse applied during a previous subfield.

That is, as shown in FIG. 4, a process of alternately applying a sustain discharge pulse to the X and Y electrodes may be repeated a number of times corresponding to a weight of the first subfield SF1 during the sustain period S1 of the first subfield SF1.

During the falling period of the reset period R2 of the second subfield SF2, the Vnf voltage may be applied to the Y electrode during a period Tnf1 after gradually decreasing a voltage of the Y electrode to the Vnf voltage from the Vs voltage. In this case, the X electrode and the A electrode may be respectively biased with the Ve voltage and the reference voltage. A voltage difference between the Y electrode and the X electrode increases as the voltage of the Y electrode is gradually decreased. Thus, a weak reset discharge may be generated between the Y and X electrodes and between the Y and A electrodes. Due to the reset discharge, wall charges formed on the Y electrode, X electrode, and the A electrode are erased. In addition, a wall voltage between the X and Y electrodes may be set to close to 0V by controlling the Ve voltage and the Vnf voltage so as to efficiently perform an addressing operation during the address period A2 of the second subfield SF2. That is, a (Ve-Vnf) voltage may be set to close to a discharge firing voltage Vfxy between the Y electrode and the X electrode.

In this case, when there are too many wall charges to be erased, a period during which the voltage of the Y electrode is maintained at the Vnf voltage may be increased. That is, most or all of the wall charges may be erased by increasing a period during which a voltage difference between the Y electrode and the X electrode is maintained close to the discharge firing voltage. As shown in FIG. 3B, when the wall charges are not fully erased while the voltage of the Y electrode is decreased, the wall charges are initialized to the wall charge state of FIG. 3A by increasing a period during which the voltage of the Y electrode is maintained at the Vnf voltage. Therefore, when numerous wall charges are formed due to a lot of sustain discharge pulses applied to a previous subfield, a period of application of the Vnf voltage to the Y electrode may be increased so as to initialize the wall charges to a wall charge state as shown in FIG. 3A.

That is, as shown in FIG. 4, the Vnf voltage may be applied to the Y electrode during the Tnf1 period in the falling period of the reset period R2 of the second subfield SF2, and the Vnf voltage may be applied to the Y electrode during a Tnf2 period that is longer than the Tnf1 period in a falling period of a reset period R3 of the third subfield SF3.

As described, according to the first exemplary embodiment of the present invention, a period of applying the Vnf voltage to the Y electrode may be increased during a falling period of a reset period of the next period when a lot of sustain discharge pulses are applied to the X and Y electrodes during a sustain period of a previous subfield. Then, wall charges can be maximally erased while the voltage of the Y electrode is maintained at the Vnf voltage so that the wall charges can be initialized to the wall charge state of FIG. 3A.

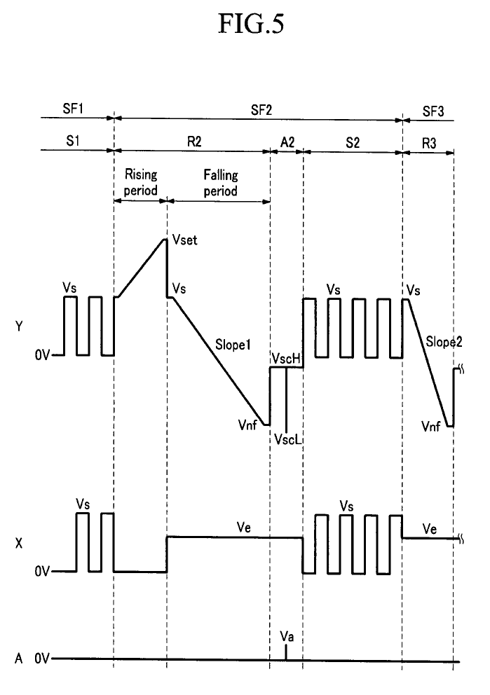

FIG. 5 illustrates a driving waveform diagram of a plasma display apparatus according to a second exemplary embodiment of the present invention. As shown in FIG. 5, in the second exemplary embodiment of the present invention, a decreasing slope of a voltage of the Y electrode that decreases from the Vs voltage to the Vnf voltage may be controlled in a reset period of the next subfield according to the amount of wall charges formed on the Y and X electrodes after a sustain period of a previous subfield.

Similar to the first exemplary embodiment, the amount of wall charges to be erased may increase as the number of sustain discharge pulses of the previous subfield increases. According to the second exemplary embodiment of the present invention, the wall charges may be initialized to the wall charge state of FIG. 3A by increasing the decreasing slope of the voltage of the Y electrode in a falling period of a reset period of the next subfield. For example, a steepness of a slope between the decrease from Vs to Vnf may correspond to a number of sustain discharge pulses in a previous subfield.

Therefore, as shown in FIG. 5, the voltage of the Y electrode may be decreased to the Vnf voltage from the Vs voltage with a first slope Slope1 during a falling period of a reset period R2 of the second subfield SF2, and the voltage of the Y electrode may be decreased with a second slope Slope2 that is steeper that the first slope Slope 1 during a falling period of a reset period R3 of the third subfield SF3. FIG. 5 is similar to FIG. 4 except that the decreasing slope of the voltage of the Y electrode is controlled in the reset period according to a subfield, rather than a length of applying of the Vnf voltage. Therefore, detailed descriptions thereof will be omitted.

As described, the voltage of the Y electrode may be decreased from the Vs voltage to the Vnf voltage with a steeper decreasing slope in the falling period of the reset period as the amount of wall charges to be erased is increased. Accordingly, a voltage difference between the X electrode and the Y electrode may be increased, causing a greater storing reset charge so that the wall charges formed on the X and Y electrodes may be fully or substantially fully erased as shown in FIG. 3A.

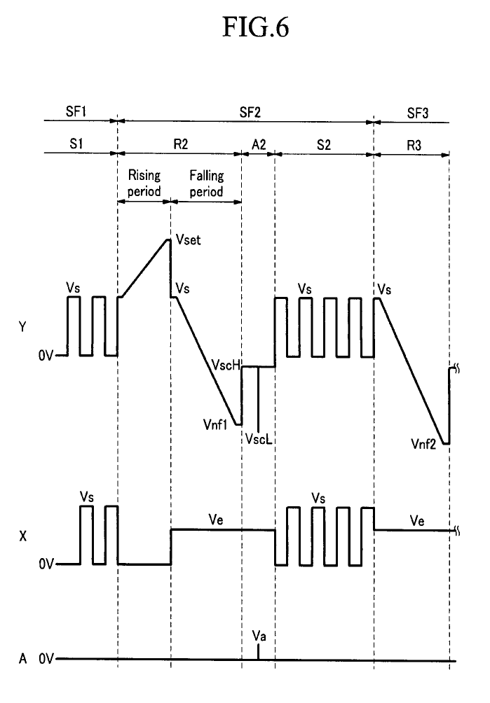

FIG. 6 illustrates a driving waveform diagram of a plasma display apparatus according to the third exemplary embodiment of the present invention.

As shown in FIG. 6, a level of the Vnf voltage applied to the Y electrode may be controlled in a falling period of a reset period of the next subfield according to the amount of wall charges formed on the Y and X electrodes after a sustain period of a previous subfield, according to the third exemplary embodiment of the present invention.

That is, as in the first and the second exemplary embodiments, the amount of wall charges to be erased in a reset period of the next subfield is increased as the number of sustain discharge pulses applied to the X and Y electrodes during the sustain period of the previous subfield, and therefore a voltage of the Y electrode may be decreased to a lower level in the falling period of the reset period of the next subfield so as to fully or substantially fully erase the wall charges formed on the X and Y electrodes. For example, a magnitude of the lowest voltage fallen to may correspond to a number of sustain discharge pulses in a previous subfield.

When the amount of wall charges to be erased is small, the voltage of the Y electrode may be gradually decreased from the Vs voltage to the Vnf voltage in the falling period of the reset period so as to initialize the wall charges to the wall charge state of FIG. 3A. When the amount of wall charges to be erased is large, the voltage of the Y electrode may be decreased to a voltage that is lower than the Vnf voltage from the Vs voltage in the falling period of the reset period.

Therefore, as shown in FIG. 6, in the falling period of the reset period R2 of the second subfield SF2, the voltage of the Y electrode may be decreased to a Vnf1 voltage from the Vs voltage while the X electrode and the Y electrode are respectively biased with the Ve voltage and the reference voltage. In addition, in a falling period of a reset period R3 of the third subfield SF3, the voltage of the Y electrode may be decreased to a Vnf2 voltage that is lower than the Vnf2 voltage from the Vs voltage while the X and A electrodes are respectively biased with the Ve voltage and the reference voltage. FIG. 6 is similar to FIG. 4 except that the voltage of the Y electrode is decreased to different voltages in different reset periods, and therefore a detailed description thereof will be omitted.

As described, the voltage of the Y electrode is applied with a relatively lower level of Vnf voltage in the falling period of the reset period of the next subfield when the amount of wall charges formed on the X and Y electrodes is relatively large in the sustain period of the previous subfield, according to the third exemplary embodiment of the present invention. Accordingly, a stronger reset discharge may be generated as a voltage difference between the X and Y electrodes is increased in the falling period of the reset period so that the wall charges formed on the X and Y electrodes may be initialized to the wall charge state of FIG. 3A.

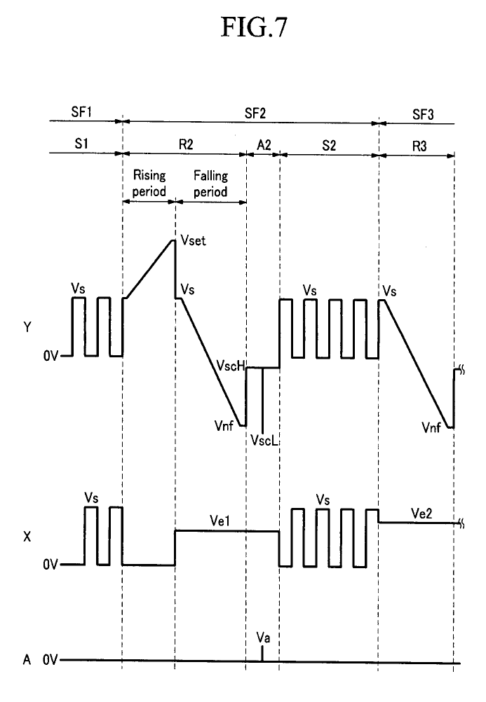

FIG. 7 illustrates a driving waveform diagram of a plasma display apparatus according to a fourth exemplary embodiment of the present invention. According to the fourth exemplary embodiment of the present invention, a level of the Ve voltage biasing the X electrode may be controlled in a falling period of a reset period and an address period of the next subfield according to the amount of wall charges formed on the X and Y electrodes after a sustain period of a previous subfield.

Similar to the first to third exemplary embodiments, the amount of wall charges to be erased may be increased as the number of sustain discharge pulses of a previous subfield is increased. Therefore, the X electrode may be biased with a voltage that is higher than the Ve voltage in the falling period of the reset period so as to erase substantially all or all the wall charges formed on the X and Y electrodes. For example, a magnitude of the biasing voltage on the X electrode may correspond to a number of sustain discharge pulses in a previous subfield.

When the amount of wall charges to be erased is small, the X electrode is biased with a Ve voltage in the falling period of the reset period and the address period so as to initialize the wall charges to the wall charge state of FIG. 3A after the falling period of the reset period. When the amount of wall charges to be erased is large, the X electrode is biased with a voltage that is higher than the Ve voltage in the falling period of the reset period and the address period. Accordingly, a voltage difference between the X and Y electrodes increases during the falling period of the reset period, causing generation of a stronger reset discharge so that the wall charges can be initialized to the wall charge state of FIG. 3A.

Therefore, as shown in FIG. 7, the X electrode may be biased with a Ve1 voltage in the falling period of the reset period R2 and the address period A2 of the second subfield SF2. Meanwhile, in a falling period of a reset period R3 and an address period (not shown) of the third subfield SF3, the X electrode may be biased with a Ve2 voltage that is higher than the Ve1 voltage. FIG. 7 is similar to FIG. 4 except that the voltage biasing the X electrode is controlled in the falling period of the reset period and the address period of a subfield, and therefore, a detailed description will be omitted.

As described, according to the fourth exemplary embodiment of the present invention, the X electrode is applied with a higher Ve voltage in the falling period of the reset period as the number of sustain discharge pulses applied to the X and Y electrodes during the sustain period of the previous subfield is increased. As described, as a level of the voltage biasing the X electrode is increased, a voltage difference between the X and Y electrodes is increased, causing generation of a stronger reset discharge so that the wall charges formed on the X and Y electrodes may be initialized to the wall charge state of FIG. 3A.

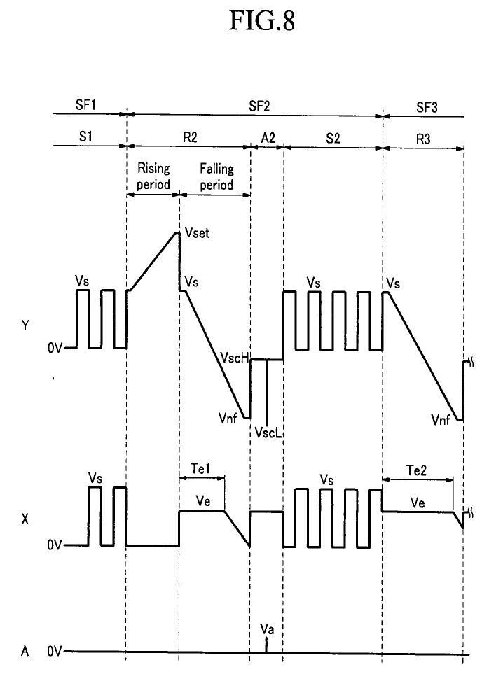

FIG. 8 illustrates a driving waveform diagram of a plasma display apparatus according to a fifth exemplary embodiment of the present invention.

As shown in FIG. 8, a floating timing of a voltage of the X electrode may be controlled in a falling period of a reset period of the next subfield according to the amount of wall charges formed on the X and Y electrodes after a sustain period of a previous subfield, according to the fifth exemplary embodiment of the present invention. For example, the floating timing of the X electrode may correspond to a number of sustain discharge pulses in a previous subfield.

That is, as in the first to the fourth exemplary embodiments, the amount of wall charges to be erased in the reset period of the next subfield may be increased as the number of sustain discharge pulses in the previous subfield is increased in the fifth exemplary embodiment, and therefore floating timing of the voltage of the X electrode may be delayed in the falling period of the reset period so as to substantially fully or fully erase the wall charges formed on the X and Y electrodes.

In general, a reset discharge may be generated between the X and Y electrodes and between the X and A electrodes during a reset period, and thus wall charges formed on the respective electrodes may be erased. That is, the voltage of the X electrode may biased with the Ve voltage while the voltage of the Y electrode may be decreased from the Vs voltage to the Vnf voltage, and accordingly, a voltage difference between the X electrode and the Y electrode may gradually increase, causing generation of a reset discharge so that the wall charges formed on the X electrode and the Y electrode may be substantially completely or completely erased. Similarly, the A electrode may be biased with the reference voltage while the voltage of the Y electrode is decreased to the Vnf voltage from the Vs voltage so that the wall charges formed on the A electrode and the Y electrode are erased. In this case, the voltage of the A electrode is biased with a voltage that is lower than the voltage of the X electrode, and therefore, a voltage difference between the A electrode and the Y electrode becomes smaller than a voltage difference between the X electrode and the Y electrode. Therefore, the wall charges formed on the A electrode may be more fully erased than the wall charges formed on the X electrode for the same period.

Accordingly, the wall charges formed on the X electrode may be over-erased while the wall charges formed on the A electrode may be sufficiently erased for an efficient addressing operation. Therefore, the X electrode may be floated, and then the voltage of the X electrode may gradually decrease from a certain point while the voltage of the Y electrode is decreasing so as to maintain a constant voltage difference between the Y electrode and the X electrode.

In this case, the amount of wall charges to be erased in the reset period of the next subfield may be increased as the number of sustain discharge pulses in the previous subfield increases, and therefore the wall charges formed on the X electrode and the Y electrodes may be erased to be initialized to the wall charge state of FIG. 3A by delaying the floating timing of the voltage of the X electrode in the falling period of the reset period.

That is, as shown in FIG. 8, in a falling period of a reset period R2 of the second subfield, the voltage of the X electrode may be biased with the Ve voltage and then floated at a time Te1 while the voltage of the Y electrode is gradually decreased to the Vnf voltage from the Vs voltage. Meanwhile, in the case of the third subfield SF3 where the amount of wall charges to be erased is greater than the second subfield SF2, the voltage of the X electrode may be biased with the Ve voltage and then floated from a time Te2 that is later than the Te1 while the voltage of the Y electrode is gradually decreased to the Vnf voltage in a falling period of a reset period R3. FIG. 8 is similar to FIG. 4 to FIG. 7, except that the X electrode is floated in the falling period of the reset period and the floating timing of the X electrode is controlled in accordance with the amount of wall charges to be erased, and therefore a detailed description thereof will be omitted.

As described, according to the fifth exemplary embodiment of the present invention, when the number of sustain discharge pulses applied to the X electrode and the Y electrode during the sustain period of the previous subfield is relatively large, the floating timing of the X electrode that has been biased with the Ve voltage may be delayed in the falling period of the reset period of the next subfield so as to more fully erase the wall charges formed on the X and Y electrodes.

The reset period of the second subfield is described as an auxiliary reset period in the first to fifth exemplary embodiments of the present invention, but a main reset period including a rising period and a falling period may be applied. In addition, the voltage waveform of the Y electrode is illustrated as a ramp waveform during the reset period in FIG. 2 and FIG. 4 to FIG. 8, but any waveform that gradually increases or gradually decreases may be applied. The waveform that gradually increases or gradually decreases may include an RC waveform or a waveform that is floated while being gradually increased or gradually decreased.

According to the exemplary embodiment of the present invention, when the previous subfield has a large number of sustain discharge pulses, the voltages applied to the X electrode and the Y electrode may be controlled in the falling period of the reset period of the next subfield so as to initialize the wall charges to a wall charge state for an efficient addressing operation, thereby reducing and/or preventing misfiring in the address period.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method for driving a plasma display having a plurality of first electrodes and a plurality of second electrodes, wherein one frame for driving the plasma display is divided into a plurality of subfields including a first subfield and a second subfield that is consecutive to the first subfield, the method comprising:
for a falling period of a reset period of the first subfield, applying a first waveform capable of erasing a first number of wall charges; and
for a falling period of a reset period of the second subfield, applying a second waveform capable of erasing a second number of wall charges, the first number and the second number being different.

2. The method as claimed in claim 1, further comprising, for a sustain period of each of the plurality of subfields, alternately applying a sustain discharge pulse having to the first and second electrodes,
wherein the number of sustain discharge pulses of the second subfield is greater than the number of sustain discharge pulses of the first subfield.

3. The method as claimed in claim 2, wherein the first number is less than the second number.

4. The method as claimed in claim 1, wherein the reset period of the second subfield is an auxiliary reset period including only the falling period.

5. The method as claimed in claim 1, wherein:
applying the first waveform includes maintaining a voltage of the plurality of second electrodes at a third voltage during a first period after gradually decreasing the voltage of the plurality of second electrodes to the third voltage from a second voltage while biasing the plurality of first electrodes with a first voltage; and
applying the second waveform includes maintaining the voltage of the plurality of second electrodes at the third voltage during a second period after gradually decreasing the voltage of the plurality of second electrodes to the third voltage while biasing the plurality of first electrodes with the first voltage.

6. The method as claimed in claim 5, wherein the second period is longer than the first period.

7. The method as claimed in claim 1, wherein:
applying the first waveform includes gradually decreasing a voltage of the plurality of second electrodes from a second voltage to a third voltage with a first slope while a voltage of the plurality of first electrodes is biased with a first voltage; and
applying the second waveform includes gradually decreasing the voltage of the plurality of second electrodes from the second voltage to a third voltage with a second slope while the voltage of the plurality of first electrodes is biased with the first voltage.

8. The method as claimed in claim 7, wherein the second slope is steeper than the first slope.

9. The method as claimed in claim 1, wherein:
applying the first waveform includes gradually increasing a voltage difference between the plurality of first electrodes and the plurality of second electrodes to a first voltage; and
applying the second waveform includes gradually increasing the voltage difference between the plurality of first electrodes and the plurality of second electrodes to a second voltage.

10. The method as claimed in claim 9, wherein the second voltage is greater than the first voltage.

11. The method as claimed in claim 9, wherein for the falling period of the reset period of the first subfield, the voltage of the plurality of second electrodes is gradually decreased from a fourth voltage to a fifth voltage while the voltage of the plurality of first electrodes is biased with a third voltage, and for the falling period of the reset period of the second subfield, the voltage of the plurality of second electrodes is gradually decreased from the fourth voltage to a sixth voltage while the voltage of the plurality of first electrodes is biased with the third voltage, the sixth voltage being less than the fifth voltage.

12. The method as claimed in claim 9, wherein the voltage of the plurality of second electrodes is gradually decreased from a fourth voltage to a fifth voltage while the voltage of the plurality of first electrodes is biased with a third voltage for the falling period of the reset period of the first subfield, and the voltage of the plurality of second electrodes is gradually decreased from the fourth voltage to the fifth voltage while the voltage of the plurality of first electrodes is biased with a sixth voltage for the falling period of the reset period of the second subfield, the sixth voltage being greater than the third voltage.

13. The method as claimed in claim 9, wherein the voltage of the plurality of first electrodes is floated at a first time in a period during which the voltage of the plurality of second electrodes is gradually decreased from a third voltage to a fourth voltage for a falling period of the reset period of the first subfield,
and the voltage of the plurality of first electrodes is floated at a second time in a period during which the voltage of the plurality of second electrodes is gradually decreased from the third voltage to the fourth voltage for a falling period of the reset period of the second subfield, and the second time is later than the first time.

14. The method as claimed in claim 13, wherein the plurality of first electrodes are floated after being biased with a fifth voltage that is less than the third voltage.

15. A plasma display, comprising:
a plasma display panel including a plurality of first electrodes, a plurality of second electrodes, a plurality of third electrodes formed crossing the first and second electrodes, and a discharge cell formed by the first, second, and third electrodes;
a controller for dividing one frame into a plurality of subfields including a first subfield and a second subfield that is consecutive to the first subfield, and driving them; and
a driver for applying a first waveform capable of erasing a first number of wall charges during a falling period of a reset period of the first subfield, and for applying a second waveform capable of erasing a second number of wall charges during a falling period of a reset period of the second subfield, the first number and the second number being different.

16. The plasma display as claimed in claim 15, wherein the driver alternately applies a sustain discharge pulses to the first electrodes and the second electrodes for a sustain period of each of the plurality of subfields, and alternately applies more sustain discharge pulses to the first and second electrodes during a sustain period of the second subfield than a sustain period of the first subfield.

17. The plasma display as claimed in claim 15, wherein the driver gradually decreases a voltage of the plurality of second electrodes from a second voltage to a third voltage with a first slope while a voltage of the plurality of first electrodes is biased with a first voltage during the first waveform, and gradually decreases the voltage of the plurality of second electrodes from the second voltage to the third voltage with a second slope while the voltage of the plurality of first electrodes is biased with the first voltage during the second waveform.

18. The plasma display as claimed in claim 17, wherein the second slope is steeper than the first slope.

19. The plasma display as claimed in claim 15, wherein the driver maintains a voltage of the second electrodes at a third voltage level for a first period after decreasing the voltage of the second electrodes from a second voltage to the third voltage during the first waveform, and maintains the voltage of the second electrodes at the third voltage level for a second period after decreasing the voltage of the second electrodes from the second voltage to the third voltage during the second waveform.

20. The plasma display as claimed in claim 19, wherein the second period is greater than the first period.

21. The plasma display as claimed in claim 15, wherein the driver gradually increases a voltage difference between the first and second electrodes to a first voltage during the first waveform, and gradually increases the voltage difference between the first and second electrodes to a second voltage during the second waveform.

22. The plasma display as claimed in claim 21, wherein the second voltage is greater than the first voltage.

23. The plasma display as claimed in claim 21, wherein the driver gradually decreases a voltage of the second electrode from a fourth voltage to a fifth voltage while a voltage of the first electrode is biased with a third voltage during the first waveform, and gradually decreases a voltage of the second electrode from the fourth voltage to a sixth voltage while the voltage of the first electrode is biased with the third voltage during the second waveform, the sixth voltage being less than the fifth voltage.

24. The plasma display as claimed in claim 21, wherein the driver gradually decreases the voltage of the second electrode from a fourth voltage to a fifth voltage while the voltage of the first electrode is biased with a third voltage during the first waveform, and gradually decreases the voltage of the second electrode from the fourth voltage to the fifth voltage while the voltage of the first electrode is biased with a sixth voltage, the sixth voltage being greater than the third voltage.

25. The plasma display as claimed in claim 21, wherein the driver floats the voltage of the first electrode at a first time while gradually decreasing the voltage of the second electrode from a third voltage to a fourth voltage the first waveform, and floats the voltage of the first electrode at a second time while gradually decreasing the voltage of the second electrode from the third voltage to the fourth voltage during the second waveform, the second time being later than the first time.

26. The plasma display as claimed in claim 25, wherein the voltage of the first electrode is floated after biasing the first electrode with a fifth voltage that is less than the third voltage.
